(19) United States
(12) Patent Application Publication
(10) Pub. No.: US 2026/0077467 A1
(43) Pub. Date: Mar. 19, 2026

(54) MULTI-USE HAND TOOL ASSEMBLY AND METHOD

(71) Applicant: SWEDE CONSTRUCTION LLC, Tempe, AZ (US)

(72) Inventor: Jim Brian Lundquist, Tempe, AZ (US)

(21) Appl. No.: 19/318,018

(22) Filed: Sep. 3, 2025

Related U.S. Application Data
(60) Provisional application No. 63/695,045, filed on Sep. 16, 2024.

(51) Int. Cl. B25F 1/00; B25H 7/04; G01D 5/14

(52) U.S. Cl. CPC B25F 1/00; B25H 7/04; G01D 5/14

(57) ABSTRACT

A multi-use hand tool assembly includes a body having a bottom portion, at least one flange extending from the bottom portion, a central portion, and an end with a plurality of holes. Each hole of the plurality of holes includes a narrowing bore extending to and ending at the central portion of the body and configured to secure a scribe and/or mark material at a marking distance. A snap-on spacer is removably coupled to the bottom portion to change at least one marking distance of at least one hole of the plurality of holes.

### CROSS-REFERENCE TO RELATED APPLICATION

This application claims priority to and the benefit of U.S. Provisional Application Ser. No. 63/695,045, filed on Sep. 16, 2024, entitled “Multi-Use Hand Tool Assembly and Method. ” The entire content of the application is incorporated herein by reference in its entirety.

### TECHNICAL FIELD

The present disclosure relates to tools for marking parts during construction and, more specifically, to a multi-use hand tool assembly and method including a scribe and/or mark material.

### BACKGROUND

It is known to use marking tools during construction, while making cabinetry and/or while installing crown molding and other features in a home, for example. Such tools are in addition to various other tools having functions separate from marking and/or scribing to mark a position of a desired dimension for a construction project. This creates at least an additional step for a carpenter and/or other user, as the user typically needs to find another tool, including a measuring device or razor or knife, before and/or after the marking and/or scribing occurs.

This not only makes the work process lengthier and less efficient, but it also may contribute to less accurate marking and/or scribing, for example.

### SUMMARY

In accordance with a first exemplary aspect, a multi-use hand tool assembly comprises a body having a bottom portion, at least one flange extending from the bottom portion, a central portion, and an end with a plurality of holes. Each hole of the plurality of holes including a narrowing bore extending to and ending at the central portion of the body and is configured to secure a scribe and/or mark material at a marking distance. A spacer is configured to be removably coupled to the bottom portion to change at least one marking distance of at least one hole of the plurality of holes.

In accordance with a second exemplary aspect, a multi-use hand tool assembly comprises a body having a bottom portion, an end, at least one flange extending from the bottom portion at the end, and a top portion having a magnet stud finder. A spacer is configured to be removably coupled to the bottom portion to change at least one marking distance of a portion of the end of the body.

In accordance with another aspect, a method of method of assembling a multi-use hand tool assembly comprises providing a body having a bottom portion, at least one flange extending from the bottom portion, a central portion, and an end with a plurality of holes, each hole of the plurality of holes including a narrowing bore extending to and ending at the central portion of the body. The method further comprises removably coupling a snap-on spacer to the bottom portion of the body to change at least one marking distance of at least one hole of the plurality of holes.

Any one or more of these aspects may be considered separately and/or combined with each other in any functionally appropriate manner. In addition, any one or more of these aspects may further include and/or be implemented in any one or more of the optional exemplary arrangements and/or features described hereinafter. These and other aspects, arrangements, features, and/or technical effects will become apparent upon detailed inspection of the figures and the following description.

### BRIEF DESCRIPTION OF THE DRAWINGS

The features of this disclosure which are believed to be novel are set forth with particularity in the appended claims. The present disclosure may be best understood by reference to the following description taken in conjunction with the accompanying drawings, in which like reference numerals identify like elements in the several figures, and in which:

FIG. 1 is a perspective view of a multi-use hand tool assembly according to an aspect of the present disclosure;

FIG. 2 is a top view of the multi-use hand tool assembly of FIG. 1;

FIG. 3 is side view of the multi-use hand tool assembly of FIG. 1;

FIG. 4 is a front view of the multi-use hand tool assembly of FIG. 1;

FIG. 5 is a perspective view of a body of the multi-use hand tool assembly of FIG. 1;

FIG. 6 is a bottom view of a snap-on spacer of the multi-use hand tool assembly of FIG. 1;

FIG. 7 is a side view of a snap-on spacer of the multi-use hand tool assembly of FIG. 1;

FIG. 8 a top perspective view of the multi-use hand tool assembly of the present disclosure having a flat knife secured to a top portion of the body of the multi-use hand tool assembly; and

FIG. 9 is a transparent perspective view of the body of the multi-use hand assembly of FIG. 1.

### DETAILED DESCRIPTION

A multi-use hand tool assembly includes a body having a bottom portion, at least one flange extending from the bottom portion, a central portion, and an end with a plurality of holes. Each hole of the plurality of holes includes a narrowing bore extending to and ending at the central portion of the body and configured to secure a scribe and/or mark material at a marking distance, such as at a marking distance from the bottom portion of the body. The multi-use hand tool also includes a spacer, such as a snap-on spacer, configured to be removably coupled to the bottom portion to change at least one marking distance of at least one hole of the plurality of holes.

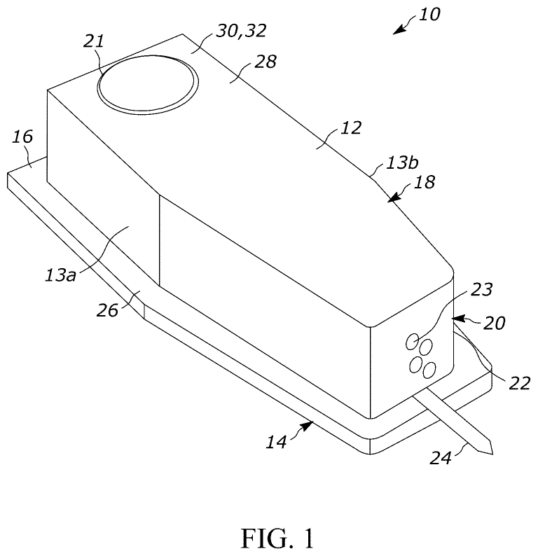

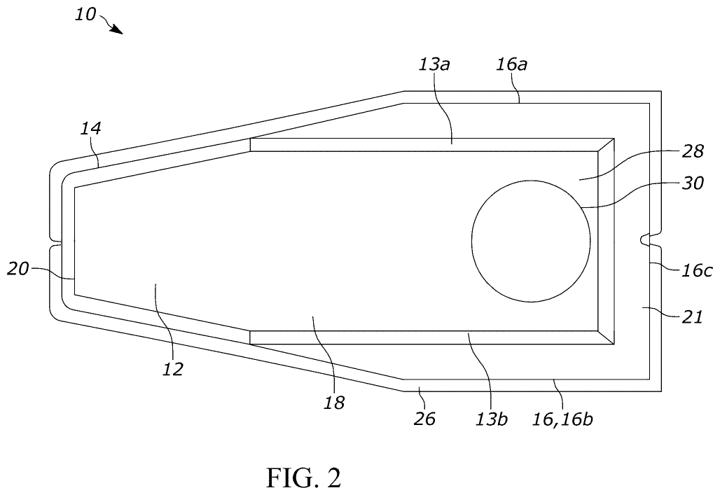

Referring now to FIGS. 1 and 2, a multi-use hand tool assembly 10 according to the present disclosure is depicted. The multi-use hand tool 10 includes a body 12 having a first side 13a, a second side 13b, a bottom portion 14 and at least one flange 16 extending from the bottom portion 14. The body 12 also includes a central portion 18 and an end 20 with a plurality of holes 22. As explained more below, each hole of the plurality of holes 22 includes a narrowing bore extending to and ending at the central portion 18 of the body 12 and is configured to receive a scribe and/or mark material 24, such as a scribe tool, at a marking distance from the bottom portion 14 of the body 12. In this example, the scribe and/or mark material 24 is secured to the at least one hole 23 of the plurality of holes 22 in a press fit manner. A spacer 26, such as a snap-on spacer 26, is removably coupled to the bottom portion 14 to change at least one marking distance of at least one hole 23 of the plurality of holes 22, as explained more below.

The multi-use hand tool assembly 10 also includes a top portion 28 having a magnet 30, which may be a magnet stud finder 30. More specifically, and in one example, a user of the multi-use hand tool 10 may move the top portion 28 of the multi-use hand tool assembly 10 across a wall. The magnet 30 in the top portion 28 will magnetize to a metal portion disposed behind the wall, such as a screw attached to a vertical stud of the wall. This allows the user to locate where he or she needs to put screws, for example, to fasten them securely to the wall. It will be appreciated the magnet stud finder 30 of the multi-use hand tool assembly 10 may be used to find studs in various other locations and materials and still fall within the scope of the present disclosure.

In another example, the multi-use hand tool assembly 10 includes an attachment mechanism 32 disposed on the top portion 28. In one example, the attachment mechanism is the magnet 30 configured to receive a flat knife and/or a razor or another tool that may be used to scribe and/or score materials. Alternatively and/or additionally, the attachment mechanism 32 may be different from the magnet and include any other mechanism capable of securing the flat knife and/or razor and/or another tool and still fall within the scope of the present disclosure. Still further, while the magnet 30 of the attachment mechanism 32 is round in shape, it will further be appreciated that the magnet 30 and/or the attachment mechanism 32 may alternatively take the form of various other shapes and again still fall within the scope of the present disclosure.

In addition, in one example, the end 20 of the body 12 is a first end 20 and the body 12 further includes a second end 21 disposed opposite the first end 20, as depicted in FIG. 2, for example. The at least one flange 16 extends from the bottom portion 14 of the body 12 from only the second end 21, a portion of the first side 13a of the body 12, and a portion of the second side 13b of the body 12. More specifically, and as depicted in FIG. 2, the at least one flange 16 in this example includes a first flange 16a extending from a portion of the first side 13a of the body 12, a second flange 16b extending from a portion of the second side 13b of the body 12, and a third flange 16c extending only from the second end 21 of the body 12. The at least one flange 16 does not extend from the first end 20 of the body 12.

The at least one flange 16 and each of the first, second and third flanges 16a, 16b, and 16c are used to mark door jams or any other component that needs a ¼ inch or a 3/16^{th} inch reveal. In one example, door trim in construction is typically ¼ inch reveal. The flange 16c including the snap-on spacer 26 attached thereto, which is depicted in FIG. 2, for example, may be disposed on the door jam, or another construction surface, and a mark using one's pencil or other writing instrument, may be made along the border of the snap-on spacer, corresponding to the ¼ inch position. Alternatively, the user may remove the snap-on spacer 26 from the body 12, and now the width of the third flange 16c is 3/16^{th} inches (as opposed to ¼ inch when the snap-on spacer 26 is coupled to the body 12). In this example, the user may then place the third flange 16c onto the door jam or frame of the door, mark the position of the edge of the flange 16c on the door jam or frame, which corresponds to 3/16^{th} inches. This mark may be made all around the entire frame of the door, such that there is an even reveal all around the door. This then marks the location of a trim to be installed on a door, for example and in this example.

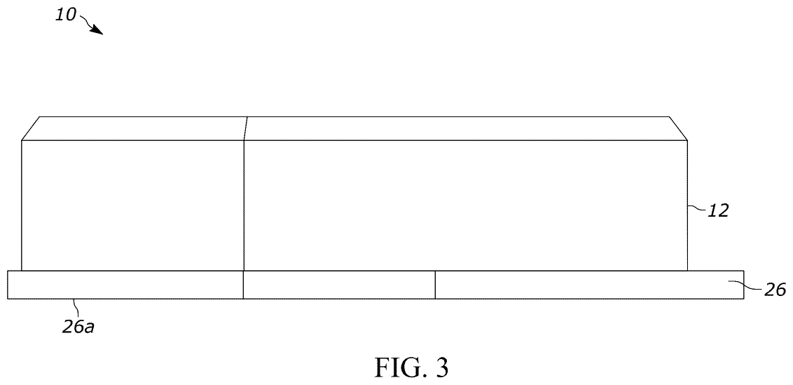

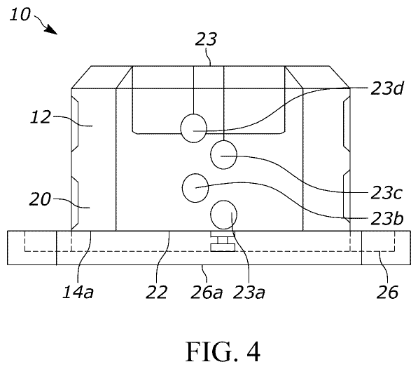

Referring now to FIGS. 3 and 4, each hole 23 the plurality of holes 22 disposed on the first end 20 of the body 12 of the multi-use hand tool 10 includes a set marking distance from a bottom surface 14a of the bottom portion 14 of the body 12. More specifically, the plurality of holes 22 includes a first hole 23a with a set marking distance of ⅛ inches from a bottom surface 14a of the body 12, and a second hole 23b with a set marking distance of ¼ inches from the bottom surface 14a of the body 12. The plurality of holes 22 also includes a third hole 23c with a set marking distance of ⅜ inches from the bottom surface 14a of the body 12, and a fourth hole 24d with a set marking distance of ½ inches from the bottom surface 14a of the body 12.

When the snap-on spacer 26 is coupled to the body 12 of the multi-use hand tool assembly 10, as depicted in FIGS. 1-4, for example, each hole 23a, 23b, 23c. 23d has a distance from a bottom surface 26a of the snap-on spacer 26 that is greater than the marking distance of each hole 23a, 23b, 23c, and 23d from the bottom surface 14a of the body 12. More specifically, the first hole 23a has a set marking distance of 3/16 inches from a bottom surface 26a of the spacer 26, and the second hole 23b has a set marking distance of 5/16 inches from the bottom surface 26a of the spacer 26. The third hole 23c has a set marking distance of 7/16 inches from the bottom surface 26a of the body 26, and the fourth hole 24d has a set marking distance of 9/16 inches from the bottom surface 26a of the spacer 26. It will be appreciated that the plurality of holes 22 may include more or fewer than the four holes 23a, 23b, 23c, and 23d, each additional or fewer hole may also have a set marking distance from both the bottom surface 14a of the bottom portion of the body 12 and the bottom surface 26a of the snap-on spacer 26 and still fall within the scope of the present disclosure.

So configured, a user may insert the scribe and/or mark material 24 at one of the first, second, third or fourth holes 23a, 23b, 23c, 23d corresponding to each marking distance to mark a desired marking distance on a material using the multi-use hand tool assembly 10 of the present disclosure. Having the various holes 23a, 23b, 23c, 23d each corresponding to a different marking distance provides flexibility and accuracy in using the multi-use hand tool assembly 10. For example, and in one example, the scribe and/or mark material 24 (FIG. 1) when inserted into one of the first, second, third or fourth holes 23a, 23b, 23c and 23d, is used to mark a base board. If there is an irregularly size floor onto which the baseboard will be installed, the scribe and/or mark material 24 of the multi-use hand tool 10 is used to scribe the base board, which may then be taken to a saw (or other cutting device) and cut along the marking from the scribe and/or mark material 24. As a result, the base board will now have a nice tight fit along the floor after installation.

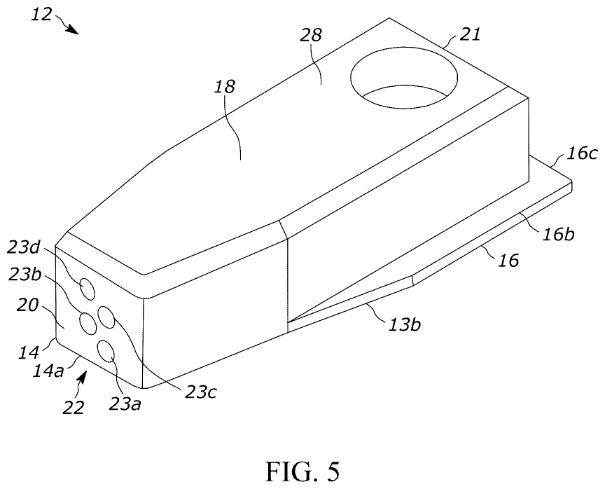

Referring now to FIG. 5, a perspective view of the body 12 of the multi-use hand tool assembly 10 of the present disclosure is depicted without the magnet 30 disposed on the top portion 28 and without the snap-on spacer 26 coupled to the bottom portion 14 and the at least one flange 16 of this example. In this example, and as noted, when the snap-on spacer 26 is removed from the body 12 of the multi-use hand tool assembly, the set marking distance of each hole 23a, 23b, 23c and 23d of the plurality of holes 22 from the bottom surface 14a of the bottom portion 14 of the body 12 is of course less than the set marking distance of each hole 23a, 23b, 23c and 23d of the plurality of holes 22 from the bottom surface 26a of the spacer 26 when the snap-on spacer 26 is coupled to the body 12. In this example, the first hole 23a has a set marking distance of ⅛ inches from a bottom surface 14a of the body 12, and the second hole 23b has a set marking distance of ¼ inches from the bottom surface 14a of the body 12.

The third hole 23c has a set marking distance of ⅜ inches from the bottom surface 14a of the body 12, and the fourth hole 24d with a set marking distance of ½ inches from the bottom surface 14a of the body 12. It will be appreciated that the holes 23a, 23b, 23c and 23d of the plurality of holes 22 of the body 12 may have different set marking distances (known to the user) from the bottom surface 14a of the bottom portion 14 of the body 12 and still fall within the scope of the present disclosure. One of ordinary skill in the art will understand this change and flexibility of multi-use hand tool 10 may be based on whether the snap-on spacer 26 is coupled to the body 12 of the multi-use hand tool 10.

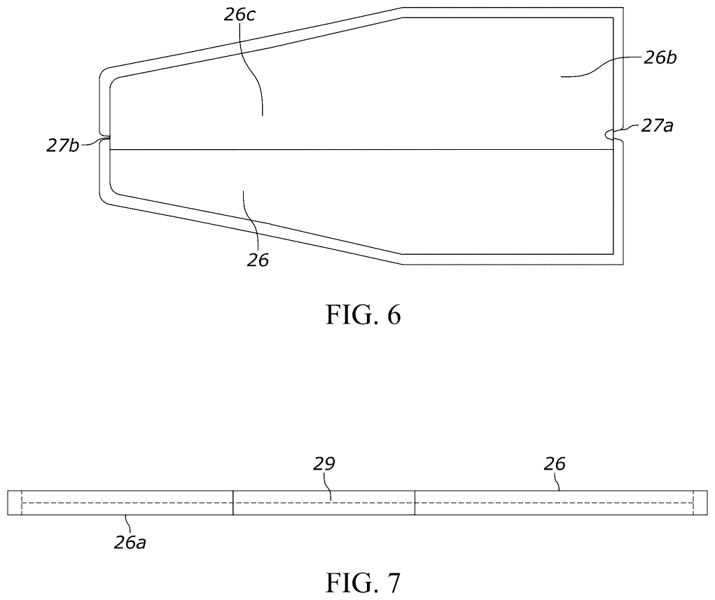

Referring now to FIG. 6, a bottom view of the snap-on spacer 26 is depicted. As shown, the snap-on spacer 26 includes a main body portion 26b having essentially the same shape as the top portion 28 and the at least one flange 16 of the body 12 of the multi-use hand tool assembly 10. In addition, the snap-on spacer 26 also includes a tapered body portion 26c extending from the main body portion 26b, which likewise is essentially the same shape as a tapered portion of the body 12 having the end 20 of the multi-use hand tool assembly 10, as depicted in FIG. 5, for example. So configured, by having essentially the same shape, the snap-on spacer 26 is easily coupled to and uncoupled from the body 12 of the multi-use hand tool assembly 10. In addition, the snap-on spacer 26 also includes a first tick 27a disposed adjacent to the main body portion 26b near a central portion of the main body portion 26b. A second tick 27b is disposed adjacent to the tapered body portion 26c again near a central portion of the tapered body portion 26c. The first and second ticks 27a, 27b are aligned with each other and thus denote a vertical line along the length of the snap-on spacer 2, as depicted in FIG. 6, such as when it is secured to the body 12, and the multi-use hand tool assembly 10 is being used as a stud finder, for example. As depicted in FIG. 7, a side view of the snap-on spacer 26 shows that a height of the spacer is ⅛^{th} of an inch, and a height of the snap-on spacer 26 from a center line 29 of the snap-on spacer 26 is 1/16^{th} of an inch.

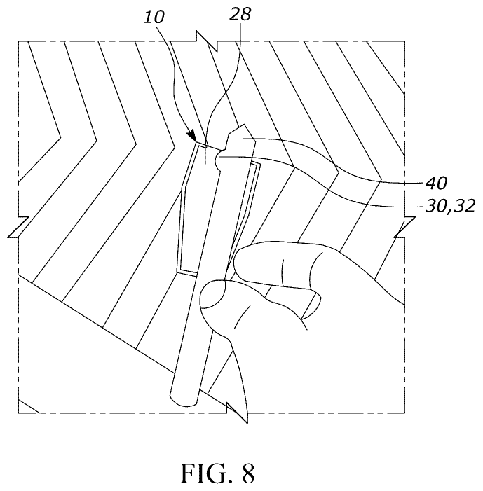

Referring now to FIG. 8, the multi-use hand tool assembly 10 of the present disclosure is depicted with flat knife coupled thereto. More specifically, and as noted above relative to FIGS. 1 and 2 for example, FIG. 8 also show the multi-use hand tool assembly 10 having the attachment mechanism 32 disposed on the top portion 28. In this example, the attachment mechanism is the magnet 30 receives a flat knife 40. As also noted above, a razor (not shown) or another tool that may alternatively be secured to the attachment mechanism 32, e.g., here the magnet, and/or used to scribe and/or score materials. In one example, when the flat knife 40 is coupled to the magnet 30, with the spacer 26 on the body 12, the distance between the flat knife 40 disposed on the top portion 28 of the body 12 and the bottom surface 26a of the spacer 26 is 3/16^{th} inches, which in some examples in an industry standard size for various construction applications, such as cabinets. When the spacer 26 is removed from the body 12, the distance between the flat knife 40 disposed on the top portion 28 of the body 12 and the bottom surface 14a of the bottom portion 14 of the body 12 (see, e.g., FIG. 5) is ¾ of an inch, which is also a typical industry standard for several construction applications.

In this example, and during use of this functionality of the multi-use hand tool assembly 10, a user puts an index finger on the flat knife 40 disposed on the magnet 30 of the body 12 and his or her thumb on a side portion of the body 12. The user then places the bottom surface 14a of the bottom portion 14 of the body 12 onto a flat surface that may be abutting but is at least adjacent to a side of a filler in the cabinet industry, for example. The user then runs the flat knife 40 along the length of the piece of filler to mark with the knife 40 a portion of the filler a distance of ¾ an inch from a boundary edge of the filler, for example. In one example, the filler (not shown) may have tape disposed thereon, such that when the user moves the flat knife 40 along the length of the piece of filler to mark ¾ inch dimension with the flat knife 40 based on the dimensions of the body 12 (with the snap-on spacer 26 removed from the body 12), the flat knife 40 cuts the tape disposed on the filler at this dimension of ¾ of an inch. As a result, the user may then pull the cut portion of the tape off of the filler, which is then the mark on the filler that shows the portion of the filler that needs to be cut and/or removed with a saw for example in the cabinet industry. The height of the body 12 being ¾ inches is consistent with thickness of cabinets in the industry, which are typically ¾ of an inch thick.

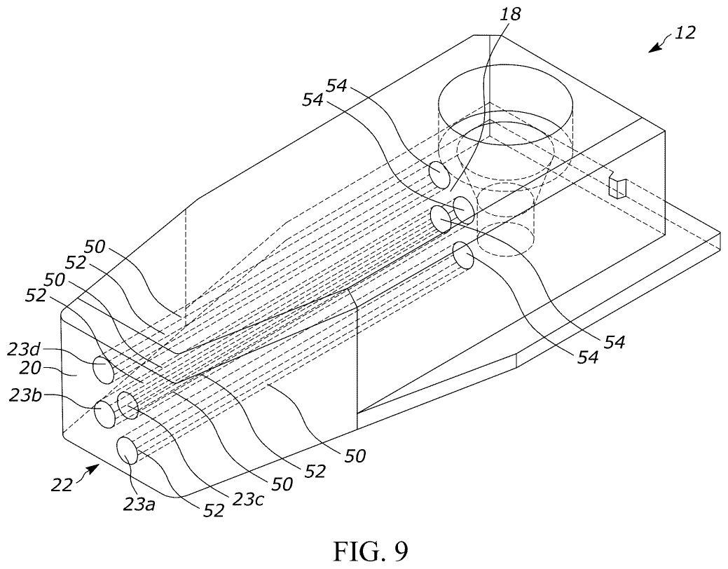

Referring now to FIG. 9, a transparent perspective view of the body 12 of the multi-use hand tool assembly 10 of the present disclosure is depicted. As explained above, the body 12 also includes the central portion 18 and the end 20 with the plurality of holes 22. Each hole 23a, 23b, 23c, 23d of the plurality of holes 22 includes a narrowing bore 50 extending to and ending at or approximately at the central portion 18 of the body 12 and is configured to receive the scribe and/or the mark material 24, such as a scribe tool, at a marking distance corresponding to each hole 23a, 23b, 23c, and 23d. Each narrowing bore 50 includes an inlet 52 having a first diameter D1 and end portion 54 having a second diameter D2 that is less than the first diameter D1, contributing to the narrowing geometry of each bore. Said another way, each hole 23a, 23b, 23c and 23d includes a taper that reduces, such as at 0.01 degree. It will be appreciated that the holes 23a, 23b, 23c, 23d may include the taper that reduces at another degree to create the narrowing bore 50, allowing the scribe or mark material 24 to be securely inserted into the bore, and still fall within the scope of the present disclosure.

At least in view of the foregoing, it will be understood that the multi-use hand tool assembly 10 of the present disclosure may be assembled according to one or more of the following methods. For example, a method of assembling the multi-use hand tool assembly 10 of the present disclosure includes providing the body 12 having the bottom portion 14, at least one flange 16 extending from the bottom portion 14, the central portion 18, and the end 20 with the plurality of holes 22, each hole of the plurality of holes 22 including a narrowing bore extending to and ending at the central portion 18 of the body 12. The method further includes removably coupling the snap-on spacer 26 to the bottom portion 14 of the body 12 to change at least one marking distance of at least one hole 23a, 23b, 23c, and 23d of the plurality of holes 22.

In one example, the method may further include securing the scribe 24 and/or the mark material 24 to one hole 23a, 23b, 23c, 23d of the plurality of holes 22, with at least one hole 23a, 23b, 23c, 23d having a known marking distance from the bottom surface 14a of the bottom portion 14 of the body 12 and the bottom portion 26a of the snap-on spacer 26. The method of assembling may still further include providing the body 12 having the top portion 28 with the magnet 30, which may be the magnet stud finder. The method may still further comprise providing the body 12 having the top portion 28 with the attachment mechanism 32, such as the magnet 30, coupled to the top portion 28.

In another example, the method may further comprise removably coupling the flat knife 40 and/or the razor 40 to the magnet 30 on the top portion 28. In addition, the method may also include optionally removing the snap-on spacer 26 from the body 12 and changing again at least one marking distance of at least one hole 23a, 23b, 23c, 23d of the plurality of holes 22.

At least in view of the foregoing, it will be appreciated that the multi-use hand tool assembly 10 and methods of the present disclosure include several advantages. For example, the multi-use hand tool assembly 10 essentially includes at least several different tools for a user, with a size that may easily fit into a user's hand and be easily manipulated with one hand of the user. The several tools include the scribe 24 and/or marking material 24 that may be placed in one of the holes 23a, 23b, 23c, and 23d of the plurality of holes 22 of the body 12, with each hole 23a, 23b, 23c, 23d having a known marking distance for ease of use in marking construction materials.

In addition, the snap-on spacer 24 may be removably secured to the body 12, such that the marking dimension of each hole 23a, 23b, 23c and 23d is easily changed according to a known dimension when the snap-on spacer 26 is coupled to the body 12 and likewise removed from the body 12. This helps the user to more easily know the marking distance being marked according to one or more holes in which the scribe 24 or marking material 24 is disposed and whether the snap-on spacer 26 is secured to the body 12. In addition, the multi-use tool assembly 10 further includes the magnet 30 on the top portion 28 of the body 12, and the magnet may be used a stud finder, allowing the user to easily adapt the tool for this purpose while on job site. Still further, the magnet 30 may be used as the attachment mechanism 32, which receives another scribing or cutting tool, such as the flat knife 40. This allows the multi-use tool assembly 10 to also function as a knife and/or a cutting tool to mark tape on a filler, such as filler used in the cabinet industry, for example. Further, the flange 16 extending from the body 12 is another tool that may be used to mark a known marking distance on one or more desired surfaces, such as the door trim, according to standard marking dimensions, as explained above.

So configured, the compact, easily manipulated multi-use hand tool assembly 10 of the present disclosure combines a variety of tools for various purposes, allowing a user to more efficiently measure, mark, and ultimately cut various parts used in construction, such as base boards, door trims and jams, and fillers for cabinets. By having the several tools and related functionality of each tool combined into the single multi-use hand tool assembly 10, several construction processes are more efficient, leading to more accurate overall processes as well. This is at least because a user does not have to stop what he or she is doing and find another single-use tool with a single functionality, for example.

The figures and description provided herein depict and describe preferred embodiments of the multi-use hand tool assembly and method of the present disclosure for purposes of illustration only. One skilled in the art will readily recognize from the foregoing discussion that alternative embodiments of the components illustrated herein may be employed without departing from the principles described herein. Thus, upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

What is claimed:

1. A multi-use hand tool assembly, comprising:
a body having a bottom portion, at least one flange extending from the bottom portion, a central portion, and an end with a plurality of holes, each hole of the plurality of holes including a narrowing bore extending to and ending at the central portion of the body and configured to secure a scribe and/or mark material at a marking distance; and
a spacer configured to be removably coupled to the bottom portion to change at least one marking distance of at least one hole of the plurality of holes.

2. The multi-use hand tool assembly of claim 1, wherein the body further comprises a top portion having a magnet stud finder.

3. The multi-use hand tool assembly of claim 1, wherein the body further comprises a top portion and an attachment mechanism disposed on the top portion, the attachment mechanism including a magnet configured to receive a flat knife and/or razor that may be used to scribe and/or score materials.

4. The muti-use hand tool assembly of claim 1, wherein the scribe and/or the mark material is configured to be secured to at least one hole of the plurality of holes in press fit manner.

5. The multi-use hand tool assembly of claim 1, wherein the end of the body is a first end and body further includes a second end disposed opposite the first end, wherein the at least one flange extending from the bottom portion of the body extends from only the second end of the body.

6. The multi-use hand tool assembly of claim 1, wherein each hole of the plurality of holes includes a set marking distance from a bottom surface of the bottom portion of the body, including a first hole with a set marking distance of ⅛ inches from the bottom surface of the bottom portion of the body, a second hole with a set marking distance of ¼ inches from the bottom surface of the bottom portion of the body, a third hole with a set marking distance of ⅜ inches from the bottom surface of the bottom portion of the body, and a fourth hole with a set marking distance of ½ inches from the bottom surface of the bottom portion of the body.

7. The multi-use hand tool assembly of claim 1, wherein, the spacer is a snap-on spacer, and each hole has a distance from a bottom surface of the snap-on spacer that is greater than the marking distance of each hole from the bottom surface of the body.

8. A multi-use hand tool assembly, comprising:
a body having a bottom portion, an end, at least one flange extending from the bottom portion at the end, and a top portion having a magnet stud finder; and
a snap-on spacer configured to be removably coupled to the bottom portion to change at least one marking distance of a portion of the end of the body.

9. The multi-use hand tool assembly of claim 8, further comprising an attachment mechanism disposed on the top portion of the body, the attachment mechanism including a magnet configured to receive a flat knife and/or razor configured to scribe and/or score at least one material.

10. The multi-use hand tool assembly of claim 8, wherein the body further comprises a central portion and a plurality of holes at the end of the body, each hole of the plurality of holes including a narrowing bore extending to and ending at the central portion of the body and configured to secure a scribe and/or mark material at a marking distance.

11. The multi-use hand tool assembly of claim 8, wherein the end of the body is a first end and body further includes a second end disposed opposite the first end, wherein the at least one flange extending from the bottom portion of the body extends from the second end of the body only.

12. The multi-use hand tool assembly of claim 10, wherein each hole of the plurality of holes includes a set marking distance from a bottom surface of the bottom portion of the body, including a first hole with a set marking distance of ⅛ inches from the bottom surface of the bottom portion of the body, a second hole with a set marking distance of ¼ inches from the bottom surface of the bottom portion of the body, a third hole with a set marking distance of ⅜ inches from the bottom surface of the bottom portion of the body, and a fourth hole with a set marking distance of ½ inches from the bottom surface of the bottom portion of the body.

13. The multi-use hand tool assembly of claim 11, wherein, the spacer is a snap-on spacer, and the first hole has a set marking distance of 3/16 inches from a bottom surface of the spacer, the second hole has a set marking distance of 5/16 inches from the bottom surface of the spacer, the third hole has a set marking distance 7/16 inches from the bottom surface of the spacer, and the fourth hole has a set marking distance of 9/16 inches from the bottom surface of the spacer.

14. A method of assembling a multi-use hand tool assembly, the method comprising:
providing a body having a bottom portion, at least one flange extending from the bottom portion, a central portion, and an end with a plurality of holes, each hole of the plurality of holes including a narrowing bore extending to and ending at the central portion of the body; and
removably coupling a snap-on spacer to the bottom portion of the body to change at least one marking distance of at least one hole of the plurality of holes.

15. The method of claim 14, further comprising securing a scribe and/or a mark material to one hole of the plurality of holes, at least one hole having a known marking distance from the bottom portion of the body and the bottom portion of the snap-on spacer.

16. The method of claim 14, further comprising providing a body having a top portion
with a magnet stud finder.

17. The method of claim 14, further comprising providing a body having a top portion
with a magnet and an attachment mechanism coupled to the top portion.

18. The method of claim 17, further comprising removably coupling a flat knife and/o razor to the magnet on the top portion.

19. The method of claim 14, further comprising optionally removing the snap-on spacer from the body and changing again at least one marking distance of at least one hole of the plurality of holes.

20. The method of claim 14, wherein providing a body having a bottom portion, at least one flange extending from the bottom portion, a central portion, and an end with a plurality of holes comprises providing the end as a first end and the body with a second end disposed opposite the first end, and disposing the at least one flange extending from the bottom portion of the body from only the second end of the body.
